(19) United States
(12) Patent Application Publication
(10) Pub. No.: US 2026/0021493 A1
(43) Pub. Date: Jan. 22, 2026

(54) CENTRIFUGE FOR ROTATING A SAMPLE CARRIER

(71) Applicant: CYTENA GMBH, Freiburg (DE)

(72) Inventors: Philipp RAUER, Freiburg (DE); Roman DEUBEL, Freiburg (DE); Luke GELDERMANS, Freiburg (DE); Julia STEINERT, Freiburg (DE); Hesham IFTEKHAR AHMAD, Freiburg (DE)

(21) Appl. No.: 18/865,467

(22) PCT Filed: May 1, 2023
(86) PCT No.: PCT/EP2023/061423

§ 371 Date: Nov. 13, 2024

(30) Foreign Application Priority Data
May 14, 2022 (LU) LU502092

(51) Int. Cl. B04B 5/04; B01L 3/00; B04B 9/10; B04B 13/00

(52) U.S. Cl. CPC B04B 5/0407; B01L 3/50853; B04B 9/10; B04B 13/00

(57) ABSTRACT

The invention relates to a centrifuge for rotating a sample carrier, having a receiving portion for receiving the sample carrier, which has at least one container for receiving a liquid sample, a rotor for rotating the sample carrier, which has a rotor receiving portion for receiving the sample carrier, and a displacement device for displacing the sample carrier along a displacement path from the receiving portion into the rotor receiving portion or vice versa. The invention is characterized in that the centrifuge has a detection device for detecting a position of the sample carrier within a detection region in the displacement path of the sample carrier.

The invention relates to a centrifuge for rotating a sample carrier.

Centrifuges into which sample carriers can be introduced are known from the prior art. The sample carriers comprise a microtiter plate having a plurality of containers, each of which is used to receive a liquid sample. The centrifuge has a rotor with a receiving portion that receives the sample carrier. The rotor is arranged in a rotor space of the centrifuge and rotates in this. As a result of the rotation of the rotor, some of the liquid sample is ejected from the sample carrier because of the centrifugal force acting on the liquid sample. A desired biological particle thus remains in the container, which can then be further processed; in particular, liquid can be introduced into the container by a dispensing apparatus and can then be ejected again from the container. A rotor housing enclosing the rotor space has an outlet through which the ejected liquid and/or particles are discharged from the rotor space. The centrifuge can be used, for example, to remove liquid and/or biological particles from the container so that only desired cells and/or magnetic beads to which DNA, RNA, proteins or cells are attached remain in the container.

The known centrifuges also have a dispensing apparatus by means of which a liquid can be introduced into the containers. To displace the sample carrier, the known centrifuge has a drive device which has a flexible belt and a stepper motor which drives the flexible belt. The flexible belt can be coupled to the sample carrier at one end and displaces the sample carrier. The centrifuge has a detection apparatus with a step counter that counts the revolutions of a drive shaft of the stepper motor. This makes it possible to determine the position of the sample carrier coupled to the flexible belt. Such a centrifuge is known from DE 20 2014 011 521 U1.

In the known design, the position of the sample carrier cannot be adjusted precisely and/or is not known. This is the result of possible slippage between a rubber shaft driven by the drive motor and the flexible belt. However, precise positioning of the sample carrier is necessary for sample carriers that have more than 384 containers. Without knowing the exact position of the container, it cannot be ensured that the dispensing device will dispense the liquid into the desired container and/or will not dispense the liquid into a region adjacent to the desired container. As a result, the known centrifuges cannot be operated with such sample containers, so their range of application is limited to sample carriers with a maximum of 384 containers.

The object of the invention is therefore to provide a centrifuge which has a wide range of applications and so that sample carriers with more than 384 containers can be used.

The object is solved by a centrifuge for rotating a sample carrier, having
a receiving portion for receiving the sample carrier, which has at least one container for receiving a liquid sample,
a rotor for rotating the sample carrier, which has a rotor receiving portion for receiving the sample carrier, and
a displacement device for displacing the sample carrier along a displacement path from the receiving portion into the rotor receiving portion or vice versa,
characterized in that
the centrifuge has a detection device for detecting a position of the sample carrier within a detection region in the displacement path of the sample carrier.

The invention has the advantage that a detection device is provided which detects the position of the sample carrier within the detection region in the displacement path of the sample carrier. The detection device allows the position of the sample carrier to be detected precisely. This makes it possible to use sample carriers with more than 384 containers. As explained in detail below, the sample carrier can be moved to a desired target position in which precise dispensing of liquid into the desired container or containers is possible. In particular, liquid is prevented from not being dispensed into the desired container.

As a result, in addition to sample carriers with 384 containers or fewer containers, sample carriers which have more than 384 containers can also be used in the centrifuge. This also makes it possible to carry out washing operations with sample carriers comprising more than 384 containers, in particular comprising 1536 containers, in which the containers, in particular all the containers of the sample carrier, are filled with a liquid which is subsequently removed from the containers by centrifugation. The containers can then be refilled with a liquid and emptied by centrifugation. These steps can be repeated several times as needed.

The sample carrier comprises a single container or a microtiter plate with a plurality of containers. Microtiter plates can be designed with a different number of containers. Microtiter plates with 6 to 4096 containers are known, wherein microtiter plates with 96, 384 or 1536 containers are usually used. The sample carrier can have a carrier device into which the microtiter plate is inserted again in a removable manner. The outer contour of the sample carrier, in particular of the carrier device and the microtiter plate, can be designed to be complementary in shape to the rotor receiving portion and/or can be connected to the rotor receiving portion in a form-fitting and/or frictional manner. This ensures that the sample carrier can be fixedly arranged in the rotor receiving portion and in particular is not movable in the radial and/or tangential directions with respect to an axis of rotation of the rotor relative to the rotor receiving portion. The rotor receiving portion may be configured such that a plane comprising a surface of the rotor receiving portion on which the microtiter plate or container is placed runs parallel to the axis of rotation of the rotor. This means that a longitudinal axis of the container of the sample carrier can extend in a direction that is perpendicular to a direction of extension of the axis of rotation of the rotor.

The liquid sample may include a liquid and biological particles. The biological particles can be cells, DNA, RNA or proteins. The liquid sample may contain one or more of the aforementioned biological particles. The liquid can be a cell suspension that can promote a growth of the cells arranged in the liquid. The particle can be a glass or polymer bead and have substantially the same volume as a cell.

The receiving portion is a portion of the centrifuge into which the sample carrier can be inserted or from which the sample carrier can be removed. This allows the sample carrier to be inserted into the receiving portion so that at least one washing operation can be carried out. Alternatively, the sample carrier can be removed from the receiving portion after one or more washing operations have been performed. Alternatively, the container or microtiter plate can be removed from the carrier device and replaced with another container or microtiter plate. In this case, it is not the entire sample carrier which is inserted into or removed from the receiving portion, but only the container or the microtiter plate.

A washing operation is understood to be an operation of the centrifuge in which the rotor is rotated at a speed that is sufficiently high that in particular some of the liquid sample is ejected from the container or containers as a result of the acting centrifugal forces. However, it can be ensured that certain biological particles are retained in the container against the centrifugal force. After the washing operation has been completed, the desired biological particle thus remains in the container.

The biological particles can be retained, for example, by cell adhesion, magnetic forces, covalent chemical bonds or suchlike. A washing operation is possible in which the bottom of the container is provided with a specific coating to which the biological particles adhere. In addition, a washing operation using magnetic beads is possible. In this washing operation, biomolecules such as DNA, RNA, or proteins are first bound to magnetic beads and then held on the bottom of the container using a magnet that is positioned below the container in the centrifuge. It is also possible for cells to be bound to magnetic beads.

In addition, a washing operation is known in which biological particles, such as proteins, for example, are bound to the bottom of the container, which has been provided beforehand with a specific reagent. In another washing operation, biological particles, preferably cells, in particular suspension cells, are first centrifuged vigorously so that a so-called pellet is formed at the bottom. The pellet then remains in the container when part of the liquid sample is ejected.

After the washing operation has been carried out, liquid can be dispensed into the container(s) using a dispensing apparatus described in more detail below. The washing operation can then be repeated.

The displacement path is understood to be a path along which the sample carrier is moved when transferred from the rotor receiving portion to the receiving portion or vice versa. The sample carrier can be displaced linearly along the displacement path by means of the displacement device.

The detection region in the displacement path is a section of the displacement path that is viewed by the detection device. The detection region extends along the displacement path of the sample carrier so that several positions of the sample carrier can be detected within the detection region. This distinguishes the detection device from other detection devices in which a position of the sample carrier can be detected optically by means of a light barrier, for example. The possibility of detecting several positions of the sample carrier located within the detection region offers the advantage that one or more containers can be assigned a target position. Thus, depending on the container into which the liquid is to be dispensed, the sample carrier can be moved to a target position assigned to the container. As a result, by looking at the detection region, it is possible for the sample carrier to be moved to several target positions. Details of the method are described in more detail below.

The rotor can be arranged in a rotor space of the centrifuge. The rotor space can be delimited by a rotor housing. The rotor housing can have an upper shell and a lower shell, which can be releasably connected to one another. The rotor housing is designed such that it delimits the rotor space, in particular in the radial, axial and tangential directions. As a result, a compact rotor housing can be provided.

A compact rotor housing is realized if the rotor housing has a cylindrical housing inner surface. The rotor housing has the cylindrical housing inner surface in a normal plane that is normal to the axis of rotation of the rotor and comprises a part of the upper shell and lower shell. The housing inner surface is understood to be the surface of the rotor housing that immediately delimits the rotor space. The cylindrical housing inner surface can be realized by correspondingly designing the upper shell and/or lower shell. The cylindrical housing inner surface allows the rotor space in which the rotor rotates to be designed as compact as possible, i.e., the distance between the rotor and the rotor housing, in particular in the radial direction, is small. The directional terms “radial”, “tangential” and “axial” are each understood to mean a direction that relates to a longitudinal axis of the centrifuge, which can run parallel to an axis of rotation of the rotor.

In a special embodiment, the centrifuge can have a computer device for controlling or regulating a drive device for driving the displacement device. The computer device can be a processor or have at least one processor. The computer device can have a printed circuit board.

The computer device can receive a signal from the detection device. In particular, the computer device can control or regulate the drive device on the basis of the signal received from the detection device when the sample carrier is at least partially arranged in the detection region. The computer device can continuously receive signals from the detection device. This means that the computer device can receive signals from the detection device even if the sample carrier is arranged outside the detection region. This offers the advantage that it is quickly detected when the sample carrier enters the detection region.

The computer device cannot control or regulate the drive device on the basis of the signals received from the detection device if the sample carrier is disposed outside the detection region. As explained below, the computer device can control the drive device on the basis of additional signals from a further detection device when the sample carrier is arranged outside the detection region.

The detection device can be designed such that the signal transmitted to the computer device contains information about the position of the sample carrier. Alternatively, the computer device can determine the position of the sample carrier in the detection region on the basis of the received signal. In both cases, the drive device is controlled or regulated on the basis of the received signal.

The further detection device can be used to detect the position of the sample carrier. The additional signal provided by the further detection device can be transmitted to the computer device. The additional signal may contain information about the position of the sample carrier. Alternatively, the additional signal may contain information by means of which the computer device can determine the position of the sample carrier.

The computer device can receive the additional signal from the further detection apparatus, in particular continuously. Thus, the computer device can receive the signal and the additional signal, in particular continuously. The computer device can control or regulate the drive device on the basis of the additional signal received from the further detection apparatus when the sample carrier is arranged outside the detection region.

As previously described, the computer device can be designed such that it determines the position of the sample carrier on the basis of the signal and/or determines the position of the sample carrier on the basis of the additional signal. Alternatively, the received signal and/or the additional signal may already contain information about the position of the sample carrier. The computer device can detect, on the basis of the received signal and/or the additional signal, whether the sample carrier is arranged within the detection region or not. Accordingly, the computer device can control the drive device on the basis of the signal or the additional signal.

In a particular embodiment, the detection region can extend in particular in the displacement direction of the sample carrier such that the extension of the detection region corresponds at least to the extension of the sample carrier in the displacement direction of the sample carrier. This means that the detection region is at least as long as the sample carrier. The detection region in the displacement direction of the sample carrier can be longer than the sample carrier. In particular, the detection region in the displacement direction can be at least as long as the carrier device of the sample carrier. The displacement direction is understood to be the direction of the sample carrier in which the sample carrier is displaced by the displacement device. This means that the sample carrier is displaced in the displacement direction so as to be displaced from the rotor receiving portion to the receiving portion or vice versa.

The displacement path of the sample carrier in the detection region can be smaller than the remaining displacement path. This has the advantage that a detection device can be used that can determine the position of the sample carrier with high accuracy. The determination can be made quickly because only one section of the entire displacement path is considered. In an alternative embodiment, the displacement path of the sample carrier in the detection region can be greater than the remaining displacement path.

The receiving portion can comprise at least part of the detection region. In addition, the detection region can be outside the rotor receiving portion. This has the advantage that the structure of the centrifuge is not complex because it is not necessary to place the detection region in the rotor receiving portion. The detection region can include a position of the sample carrier in which a dispensing device of the centrifuge dispenses liquid into the sample carrier. As explained in more detail below, this position of the sample carrier can be used as the target position. This means that the computer device controls or regulates the drive device in such a way that the sample carrier is arranged in the target position.

The detection device may be a contactless detection device for detecting the position of the sample carrier. In particular, the detection device can comprise a magnetic position sensor having a measuring principle based on the Hall effect. As a result, a simply constructed detection device can be used to detect the position of the sample carrier. In addition, the detection device can be designed such that it detects the position of the sample carrier more accurately than the further detection device. The detection device can comprise a first measuring means which is arranged on the sample carrier, in particular on the carrier device, and a second measuring means which is arranged on the receiving portion. The first measuring means can interact with the second measuring means, the interaction being contactless. The interaction can consist in that a field acting from the first measuring means acts on the second measuring means.

The second measuring means can be arranged in a fixed position and/or the second measuring means can move together with the sample carrier. Thus, the first measuring means can move relative to the second measuring means. The extension of the second measuring means in the displacement direction can define the extension of the detection region in the displacement direction. In other words, the longer the second measuring means is in the displacement direction of the sample carrier, the greater the extension of the detection region in the displacement direction. The extension of the detection region in the displacement direction can be equal to the extension of the second measuring means. The second measuring means can be a magnetorestrictive element. In contrast, the first measuring means can be a magnet.

In a particular embodiment, the speed of the sample carrier which is arranged at least partially within the detection region may differ from a speed of a sample carrier arranged outside the detection region. In particular, the speed of the sample carrier which is arranged at least partially within the detection region can be lower than a speed of a sample carrier arranged outside the detection region. This offers the advantage that, on the one hand, the sample carrier can be positioned precisely in the target position and, on the other hand, the sample carrier can be moved quickly if the sample carrier is arranged outside the detection region.

Similarly, the speed of the sample carrier may be less than the speed of the sample carrier outside the detection region when being displaced from the target position to another target position after liquid has been dispensed into the container or containers. In addition, the speed of the sample carrier can be constant if the sample carrier is arranged outside the detection region. The speed of the sample carrier depends on the speed of the drive device, in particular the speed of the drive shaft of the drive device.

The computer device can control or regulate the drive device in such a way that the speed of the sample carrier decreases within the detection region. In particular, the computer device can control or regulate the drive device in such a way that the speed of the sample carrier decreases within the detection region in the direction of a target position of the sample carrier. The reduction in speed can be continuous or incremental.

The control or regulation of the drive device by the computer device can be carried out as follows. Once the sample carrier has entered the detection region, the detection device detects a signal, such as, for example, a voltage value. The signal differs, in particular in value and/or waveform, from signals detected by the detection device when the sample carrier is not arranged in the detection region. The computer device controls the drive device in such a way that the detected signal corresponds to a target signal. When the target signal is given, the sample carrier is in the target position in which liquid can be dispensed into at least one specified container of the sample carrier. In this case, a plurality of containers of the sample carrier, which are arranged adjacent to each other in the displacement direction of the sample carrier, can each be assigned a target position.

The containers can be arranged in a matrix form. A plurality of containers can be arranged in a row that runs perpendicular to the displacement direction. In this case, the individual rows of containers can be spaced apart from each other in the displacement direction. Each container row can be assigned a target position. The sample carrier is then moved according to the method described above to the target position assigned to the container or row of containers into which the liquid is to be dispensed.

In a particular embodiment, the centrifuge can have a dispensing device for dispensing liquid into at least one container of the sample carrier arranged in a target position. As already described above, the computer device can cause the dispensing device to dispense liquid into the container or containers when the sample carrier is arranged in the target position. After dispensing the liquid into the at least one container, the computer device can cause the sample carrier to be moved to another target position. In the new target position, the dispensing device can dispense liquid into other containers. The dispensing device can be arranged such that it is in the displacement path of the sample carrier between the receiving portion and the rotor receiving portion.

The further detection device can measure a movement of the drive device, in particular of a stepper motor of the drive device. In particular, the further detection device can measure a rotational position of a drive element, such as a drive shaft, of the drive device. The further detection device can have a step counter that counts the number of revolutions of the drive shaft, and the step counter value can be transmitted as an additional signal to the computer device. The computer device can determine the position of the sample carrier on the basis of the additional signal received. Alternatively or additionally, the further detection device can determine the position of the sample carrier on the basis of the step counter value.

The position of the sample carrier can be determined via the drive device, in particular via the stepper motor, if a reference position is approached beforehand. The further detection device can have at least one reference sensor, in particular two reference sensors, in particular light sensors, by means of which at least one, in particular two, reference positions can be determined. For this purpose, a belt of the displacement device can have at least one hole, in particular two holes, which is/are detected by the reference sensor. The sample carrier is in a first reference position when a first reference sensor detects a first hole in the belt. The sample carrier is in a second reference position, which is different from the first reference position, when a second reference sensor detects a second hole in the belt. The two holes are spaced apart from each other in the displacement direction of the sample carrier.

The drive device can be designed such that it can move the sample carrier by a distance of less than 2 mm (millimeters) per displacement. In particular, the sample carrier can be moved in a range between 0.1 mm to 0.3 mm, preferably 0.1 mm to 0.2 mm. This ensures that a sample carrier with 1536 containers can be used.

In a special embodiment, the displacement device can be designed in such a way that it displaces the sample carrier in a linear direction. The displacement device can be releasably connected again to the sample carrier. The displacement device may comprise the belt which can be connected at one end to the sample carrier. For this purpose, the displacement device can have a coupling element that can be releasably connected again to the sample carrier. The connection between the sample carrier and the displacement device can be a magnetic connection.

The coupling element can thus have at least one magnet. The sample carrier can have a counter magnet or a magnetic material, such as iron. The counter magnet can be arranged on the sample carrier and/or the sample carrier can be designed in such a way that the counter magnet does not interact with the detection device, in particular the second measuring means of the detection device.

The centrifuge may comprise a belt housing in which the belt end that is remote from the sample carrier is arranged. The belt end is at least partially wound into the belt housing. The belt is therefore sufficiently flexible so that it can be wound onto the roller. In addition, the belt is sufficiently stiff to be able to displace the sample carrier. In particular, the belt is sufficiently stiff that it can displace the sample carrier from the rotor receiving portion to the receiving portion or vice versa.

The displacement device can be arranged in the rotor receiving portion to partially displace the sample carrier from the receiving portion into the rotor receiving portion or vice versa. In particular, the displacement device can move within the rotor receiving portion. In this case, the displacement device is operatively connected to the sample carrier. When there is an operative connection between the displacement device and the sample carrier, a movement of the displacement device, in particular of the belt, causes a movement of the sample carrier. Furthermore, the displacement device is designed such that it is arranged outside the rotor receiving portion when the rotor rotates. In this case, the displacement device is not operatively connected to the sample carrier. Thus, the rotor can rotate without colliding with the displacement device, in particular a component of the displacement device.

The subject matter of the invention is shown schematically in the drawings, in which elements that are the same or have the same effect are mostly provided with the same reference signs. In the drawings:

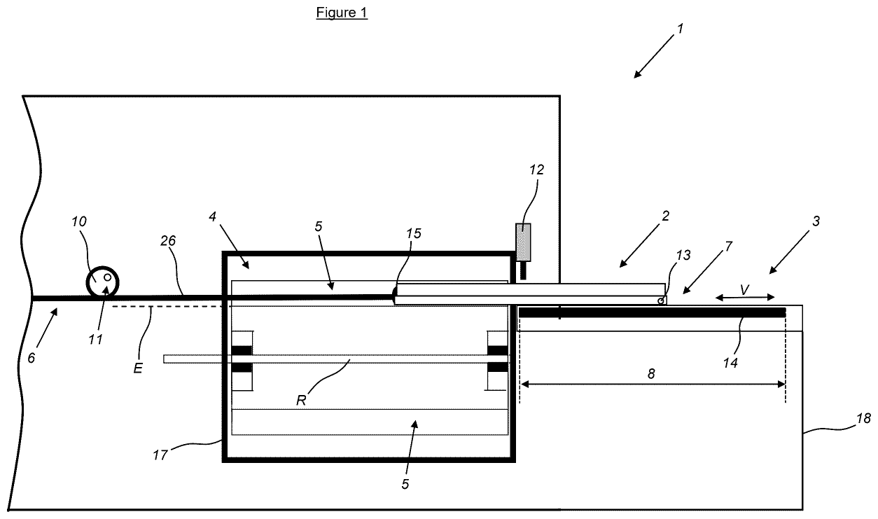

FIG. 1 shows a sectional view of part of a centrifuge according to the invention;

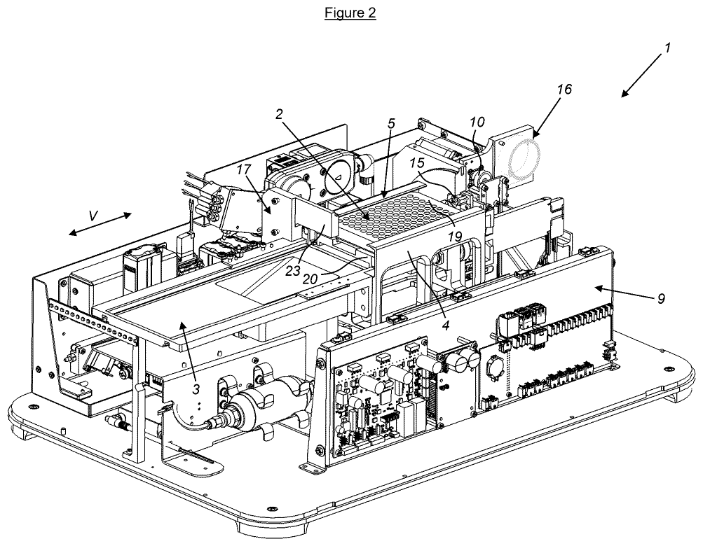

FIG. 2 shows a perspective interior view of a centrifuge with a computer device, in which the sample carrier is arranged in the rotor receiving portion;

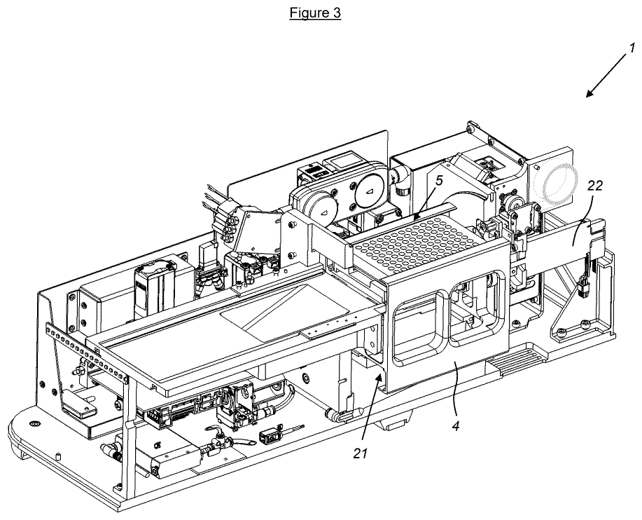

FIG. 3 shows a perspective interior view of the centrifuge, without the computer device, in which the sample carrier is arranged in the rotor receiving portion;

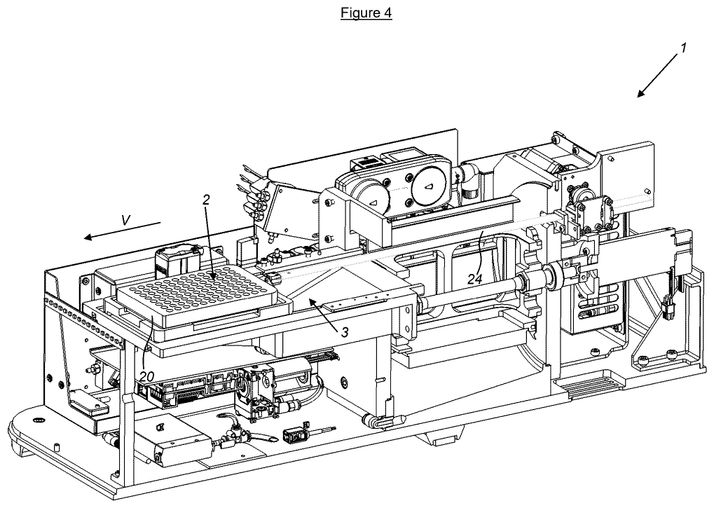

FIG. 4 shows a perspective interior view of the centrifuge, in which the sample carrier is arranged in the receiving portion;

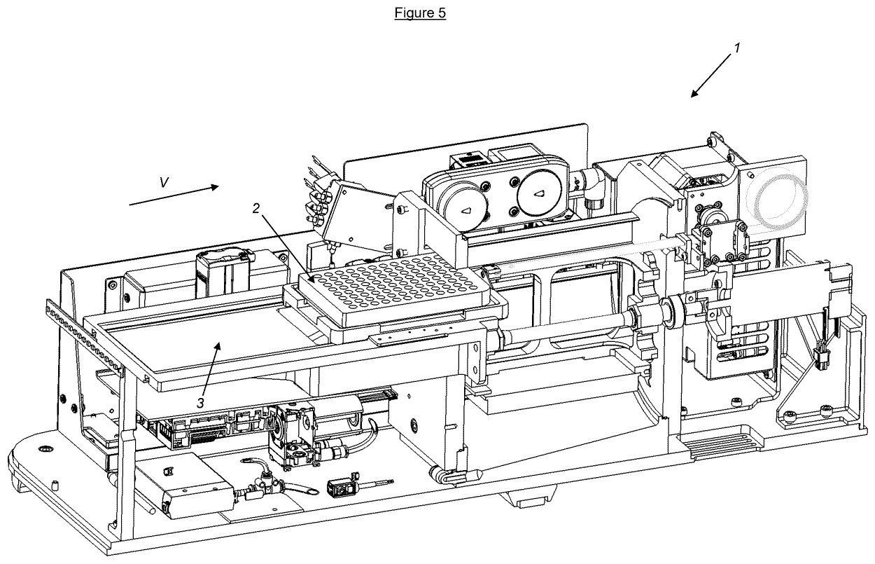

FIG. 5 shows a perspective interior view of the centrifuge in which the sample carrier is arranged in a different region of the receiving portion;

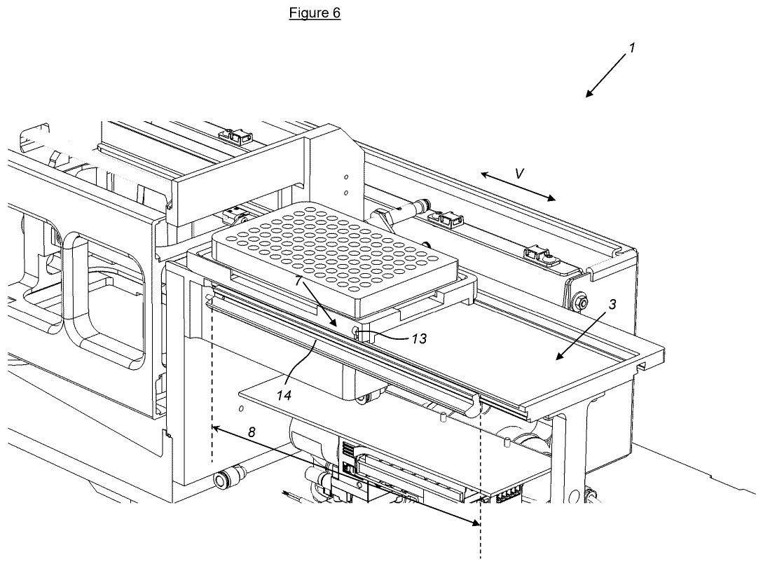

FIG. 6 shows an enlarged view of the receiving portion;

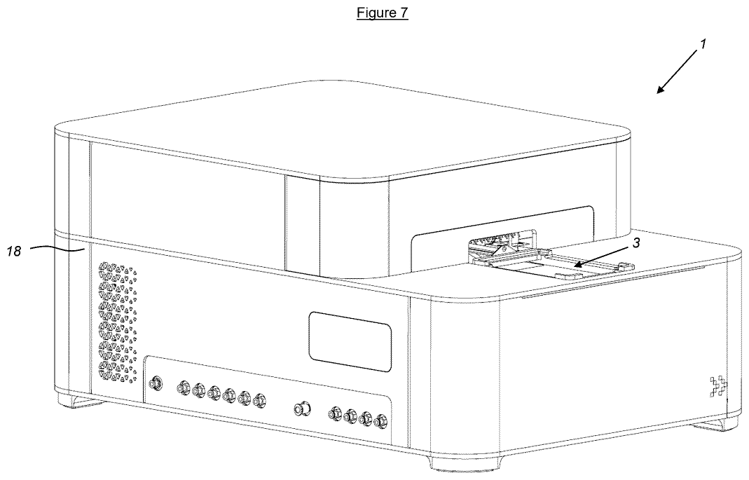

FIG. 7 shows a perspective view of the centrifuge with a centrifuge housing.

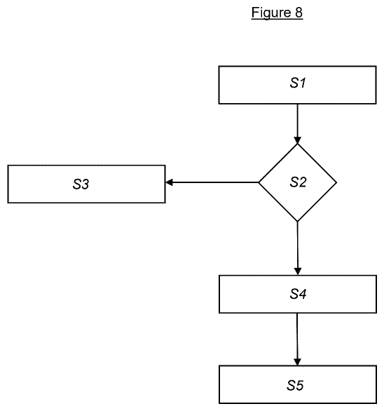

FIG. 8 shows a flow chart for the control or regulation of a drive device of the centrifuge by the computer device.

A centrifuge 1 shown in FIG. 1 is used to rotate a sample carrier 2. The centrifuge 1 has a receiving portion 3 for receiving the sample carrier 2 and a rotor 4 for rotating the sample carrier 2. The rotor 4 has a rotor receiving portion 5 for receiving the sample carrier 2. In addition, the centrifuge 1 has a displacement device 6 for displacing the sample carrier 2 along a displacement path from the receiving portion 3 to the rotor receiving portion 5 or vice versa. The centrifuge 1 also has a detection device 7, by means of which a position of the sample carrier 2 within a detection region 8 in the displacement path of the sample carrier 3 is detected.

The detection device 7 has a first measuring means 13 and a second measuring means 14. The first measuring means 13 is mounted on the sample carrier 2 and the second measuring means 14 is mounted on the receiving portion 3. The first measuring means 13 moves together with the sample carrier 2 when the sample carrier 2 is displaced in a displacement direction V by the displacement device 6. The first measuring means 13 can be a magnet.

The second measuring means 14 is arranged in a fixed position. The extension of the second measuring means 14 in the displacement direction V defines the length of the detection region 8. The second measuring means 14 is designed such that the detection region 8 forms only a section of the entire displacement path. The detection device 7 transmits a signal to a computer device 9 shown in FIG. 2. The signal may contain information about the position of the sample carrier 2 within the detection region 8.

The centrifuge 1 also has a dispensing device 12. FIG. 1 shows only one dispensing line of the dispensing device 12. However, the dispensing device 12 can have a plurality of dispensing lines (not shown) which are arranged at a distance from one another in a direction which is perpendicular to the displacement direction V. As explained in more detail below, a computer device 9 shown in FIG. 2 controls or regulates a drive device 10 on the basis of the received signal, which contains a position of the sample carrier 2 as information. In particular, the computer device 9 controls or regulates the drive device 10 such that a position of the sample carrier 2 detected by the detection device 7 corresponds to a target position of the sample carrier 2. The target positions of the sample carrier 2 can be stored in an electrical memory (not shown).

The drive device 10 may comprise a stepper motor. The centrifuge 1 can have a further detection device 11 by means of which the position of the sample carrier 2 is determined. In particular, the further detection device 11 can comprise a step counter by means of which the number of revolutions of a shaft of the drive device 10 is counted. The position of the sample carrier 2 depends on the number of revolutions of the shaft of the drive device. The further detection device 11 transmits an additional signal to the computer device 9. The signal may contain a measurement counter value or information on the position of the sample carrier 2.

The rotor 4 is arranged in an interior space of a rotor housing 17. The rotor 4 is designed such that it can rotate about a rotor axis R. The rotor axis R is supported at both ends on the rotor housing 17. The rotor 4 has two rotor receiving portions 5 which are radially opposite each other with respect to the rotor axis R. In the embodiment shown in FIG. 1, the rotor 4 is rotated into a position in which the sample carrier 2 can be displaced from the rotor receiving portion 5 into the receiving portion 3 or vice versa. The rotor receiving portion is designed such that a plane E, which has a surface of the rotor receiving portion on which the microtiter plate is placed, runs parallel to the axis of rotation of the rotor 4.

The receiving portion 3 is a portion of the centrifuge 1 which is used to receive the sample carrier 2 and is accessible from outside the centrifuge 1. This means that a user inserts the sample carrier 2 into the receiving portion 3 when, for example, a washing operation is to be carried out. Alternatively, the user can remove the sample carrier 2 from the receiving portion 3 after a washing operation has been performed. In addition, the displacement device 6 can move the sample carrier 2 into a position within the receiving portion 3 so that the dispensing device 12 can dispense liquid into the individual containers. The dispensing device 12 is mounted on the rotor housing 17.

The displacement device 6 has a belt 24 which is connected at one end to the sample carrier 2, in particular magnetically, by means of a coupling element 15. A belt end 16 shown in FIG. 2 is wound up and arranged in a belt housing (not shown) of the centrifuge 1. The drive device 10 causes, in particular by rotation of the shaft, the belt 24 and thus the sample carrier 2 to move linearly in the displacement direction V along the displacement path.

The centrifuge 1 also has a centrifuge housing 18. The rotor housing 17, the drive device 10, the dispensing device 12 and the displacement device 6 are arranged in an interior space enclosed by the centrifuge housing 18. At least part of the receiving portion 3 is not arranged in the interior space enclosed by the centrifuge housing 18.

FIG. 2 shows a perspective interior view of a centrifuge 1 with a computer device 9 and in which the sample carrier 2 is arranged in the rotor receiving portion 5. FIG. 2 shows the centrifuge 1 in more detail than FIG. 1. However, both figures show the same centrifuge 1. FIG. 2 does not show the centrifuge housing 18.

As can be seen from FIG. 2, the sample carrier 2 has a microtiter plate 19 with a plurality of containers arranged in matrix form. In addition, the sample carrier 2 has a carrier device 20 on which the microtiter plate 19 is arranged. The carrier device 20 serves to carry the microtiter plate 19 between the rotor receiving portion 5 and the receiving portion 3.

The coupling element 15 of the displacement device 6 is not connected to the sample carrier 2. This means that the coupling element 15 is arranged outside the rotor receiving portion 5.

The rotor housing 17 has a retaining portion 23. The retaining portion 23 is used to hold a dispensing device 12, shown in FIG. 1. The dispensing device 12 can have a plurality of dispensing lines which are arranged at a distance from one another in a direction perpendicular to a displacement direction V of the sample carrier. The number of dispensing lines can correspond to the number of containers arranged in a container row. Containers are arranged in a row and are spaced apart from one another in the direction perpendicular to the displacement direction.

FIG. 3 shows a perspective interior view of the centrifuge 1, in which the sample carrier 2 is arranged in the rotor receiving portion 5. FIG. 3 differs from FIG. 2 in that the computer device 9 is not shown. It can be seen from FIG. 3 that the rotor 4 has a further rotor receiving portion 21. The further rotor receiving portion 21 is located diametrically opposite the rotor receiving portion 5 with respect to the rotor axis R of the rotor 4 shown in FIG. 1. The centrifuge 1 has a further drive device 22 for driving the rotor axis R.

FIG. 4 shows a perspective interior view of the centrifuge 1, in which the sample carrier 2 is arranged in the receiving portion 3. The displacement device 6, in particular the coupling means 15 of the displacement device 6, is connected, in particular magnetically, to the sample carrier 2, in particular the carrier device 20. In order to displace the sample carrier 2 from the position in the rotor receiving portion 5 shown in FIG. 3 into the receiving portion 3, the sample carrier 2 is moved over a displacement path in a displacement direction V. For this purpose, the displacement device 6 extends partially through the rotor receiving portion 5. In the position shown in FIG. 4, the sample carrier can be removed from the receiving portion 3.

FIG. 5 shows a perspective interior view of the centrifuge 1, in which the sample carrier 2 is arranged in a different region of the receiving portion 3. The sample carrier 2 is arranged in a region of the receiving portion 3 in which the dispensing device 12 (not shown) can dispense liquid into containers of the microtiter plate 19. Starting from the position shown in FIG. 4 in the receiving portion 3, the sample carrier 2 is displaced in the displacement direction V towards the rotor receiving portion 5. In the present case, the displacement direction V is counter to the displacement direction during the displacement of the sample carrier 2 from the rotor receiving portion 5 into the receiving portion 3.

FIG. 6 shows an enlarged view of a receiving portion 3. It can be seen from FIG. 6 that the first measuring means 13 is in the form of a magnet and is mounted on the carrier device 20. The second measuring means 14 is mounted on the receiving portion 3 and extends in the displacement direction V. The second measuring means 14 is arranged in a fixed position and extends in the displacement direction V of the sample carrier 2. The length of the second measuring means 14 in the displacement direction V defines the detection region 8 in which the detection device 7 detects the position of the sample carrier 2.

FIG. 7 shows a perspective view of the centrifuge 1 with the centrifuge housing 18. FIG. 7 shows the receiving portion 3 into which the sample carrier 2 can be inserted. Starting from the position shown in FIG. 7, the sample carrier 2 is moved to the position shown in FIG. 5 for dispensing liquid into the containers.

FIG. 8 shows a flow chart for the control or regulation of the drive device 10 by the computer device 9. In a first step S1, the detection device 3 and the further detection device 11 directly or indirectly detect a position of the sample carrier 2. It can thus be determined that the position of the sample carrier 2 is within the detection region 8 if the signal from the detection device 7 is greater than a specified signal.

The further detection device 11 has a step counter for counting the revolutions of a shaft of the drive device 10. The position of the sample carrier 2 can be determined according to the step counter path. The signal provided by the detection device 3 and the signal provided by the further detection device 11 are transmitted to the computer device 9.

In a second step S2, the computer device 9 checks whether the sample carrier 2 is arranged in the detection region 8. If this is not the case, the drive device 10 is controlled or regulated in a third step S3 such that it maintains a speed or the speed of the sample carrier is increased.

If it is determined in the second step S2 that the sample carrier 2 is at least partially arranged in the detection region 8, the drive device 10 is regulated or controlled in a fourth step S4 such that the speed of the sample carrier 2 is reduced. This means that, in this case, the control of the drive device is carried out on the basis of the signal provided by the detection device 7. This occurs as long as the sample carrier 2 is arranged in the detection region 8.

In addition, the computer device 9 controls or regulates the drive device 10 such that the speed of the sample carrier 2 is reduced within the detection region 8. Thus, after the sample carrier enters the detection region 8, the speed is reduced. The speed is reduced such that it becomes zero when a detected position of the sample carrier 2 corresponds to a target position. In the target position, the measured signal corresponds to a stored target signal.

Subsequently, in a fifth step S5, the liquid is dispensed from the dispensing device 12 into the containers of the microtiter plate.

Subsequently, steps S1 to S5 are repeated until liquid has been dispensed into all desired containers of the sample carrier 2. In particular, the sample carrier 2 is moved so that new containers of a row which are adjacent to the previous container row in the displacement direction V pass under the dispensing device 12. The computer device 9 controls or regulates the drive device 10 such that the sample carrier 2 is transferred to a further target position in which the containers of the other row of containers are arranged under the dispensing device 12 so that liquid can be dispensed into them.

The speed of the sample carrier 2 is selected such that it is less than the speed of the sample carrier 2 when it is outside the detection region 8.

As already described above, a target position is assigned to the containers in each row of containers. Thus, on the basis of the signal detected by the detection device, the sample carrier 2 can control or regulate the drive device 10 such that the sample carrier is transferred to the target position.

After all or the specified number of containers have been filled with liquid, the sample carrier 2 is moved further towards the rotor receiving portion 5. As soon as the sample carrier is no longer arranged in the detection region 8, the computer device 9 controls or regulates the drive device 10 on the basis of the signal transmitted by the further detection device 11. In addition, in this case the speed of the sample carrier can be increased.

### LIST OF REFERENCE SIGNS

1 Centrifuge
2 Sample carrier
3 Receiving portion
4 Rotor
5 Rotor receiving portion
6 Displacement device
7 Detection device
8 Detection region
9 Computer device
10 Drive device
11 Further detection device
12 Dispensing device
13 First measuring means
14 Second measuring means
15 Coupling element
16 Belt end
17 Rotor housing
18 Centrifuge housing
19 Microtiter plate
20 Carrier device
21 Further rotor receiving portion
22 Further drive device
23 Retaining portion
24 Belt
E Plane
V Displacement direction
S1-S5 First step to fifth step

1.-17. (canceled)

18. A centrifuge for rotating a sample carrier, comprising:
a receiving portion for receiving the sample carrier, which has at least one container for receiving a liquid sample;
a rotor for rotating the sample carrier, which has a rotor receiving portion for receiving the sample carrier; and
a displacement device for displacing the sample carrier along a displacement path from the receiving portion into the rotor receiving portion or vice versa;
wherein the centrifuge has a detection device for detecting a position of the sample carrier within a detection region in the displacement path of the sample carrier.

19. The centrifuge according to claim 18, wherein the centrifuge comprises a computer device for controlling or regulating a drive device for driving the displacement device.

20. The centrifuge according to claim 19, wherein:
a. the computer device receives a signal from the detection device; and/or
b. the computer device controls or regulates the drive device on the basis of a signal received from the detection device when the sample carrier is at least partially arranged in the detection region.

21. The centrifuge according to claim 19, wherein the centrifuge comprises a further detection device for detecting the position of the sample carrier.

22. The centrifuge according to claim 21, wherein:
a. the computer device receives an additional signal from the further detection device; and/or
b. the computer device controls or regulates the drive device based on an additional signal received from the further detection device when the sample carrier is arranged outside the detection region.

23. The centrifuge according to claim 18, wherein an extension of the detection region in a displacement direction (V) of the sample carrier corresponds at least to an extension of the sample carrier in the displacement direction of the sample carrier.

24. The centrifuge according to claim 18, wherein:
a. the receiving portion has at least a part of the detection region; and/or
b. the detection region is outside the rotor receiving portion; and/or
c. the detection region comprises a position of the sample carrier in which a dispensing device of the centrifuge dispenses liquid into the sample carrier.

25. The centrifuge according to claim 18, wherein the detection device is a contactless detection device for detecting the position of the sample carrier.

26. The centrifuge according to claim 18, wherein:
a. the detection device has a first measuring means which is arranged on the sample carrier and a second measuring means which is mounted on the receiving portion; and/or
b. the detection device has a first measuring means and a second measuring means which interacts with the first measuring means; and/or
c. the detection device has a second measuring means, an extension of the detection region in a displacement direction (V) defining the extension of the detection region in the displacement direction.

27. The centrifuge according to claim 26, wherein the first measuring means is a magnet and/or the second measuring means is a magnetoresistive element.

28. The centrifuge according to claim 18, wherein:
a. a speed of the sample carrier which is arranged at least partially within the detection region differs from a speed of a sample carrier arranged outside the detection region; and/or
b. a speed of the sample carrier which is arranged at least partially within the detection region is less than a speed of a sample carrier arranged outside the detection region.

29. The centrifuge according to claim 19, wherein:
a. the computer device controls or regulates the drive device in such a way that a speed of the sample carrier decreases within the detection region; and/or
b. the computer device controls or regulates the drive device such that the speed of the sample carrier decreases within the detection region in the direction of a target position of the sample carrier.

30. The centrifuge according to claim 19, wherein:
a. the centrifuge has a dispensing device for dispensing liquid into at least one container of the sample carrier arranged in a target position; and/or
b. the computer device causes the dispensing device to dispense liquid into the sample container when the sample container is arranged in the target position.

31. The centrifuge according to claim 21, wherein:
a. the further detection device comprises a step counter; and/or
b. the further detection device detects a rotational position of a drive element of the drive device.

32. The centrifuge according to claim 18, wherein:
a. the displacement device is configured to displace the sample carrier in a linear direction; and/or
b. the displacement device can be releasably connected again to the sample carrier.

33. The centrifuge according to claim 18, wherein the displacement device has a belt which can be connected at one end to the sample carrier.

34. The centrifuge according to claim 18, wherein:
a. the displacement device for displacing the sample carrier from the receiving portion into the rotor receiving portion or vice versa is arranged partially in the rotor receiving portion; and/or
b. the displacement device is configured such that it is arranged outside the rotor receiving portion when the rotor rotates.
